(19) United States
(12) Patent Application Publication
(10) Pub. No.: US 2023/0391636 A1
(43) Pub. Date: Dec. 7, 2023

(54) WATER DESALINATION, POWER GENERATION, SALT PRODUCTION, AND METHODS OF USING SALT

(71) Applicant: Yaser K. Barakat, Roanoke, VA (US)

(72) Inventor: Yaser K. Barakat, Roanoke, VA (US)

(21) Appl. No.: 18/205,849

(22) Filed: Jun. 5, 2023

Related U.S. Application Data
(60) Provisional application No. 63/348,781, filed on Jun. 3, 2022.

(51) Int. Cl. C02F 1/04; C02F 1/40; A23L 19/00; A23K 10/30; C04B 28/14; C04B 18/04; C04B 14/36; F03B 17/06

(52) U.S. Cl. CPC C02F 1/048; C02F 1/40; A23L 19/00; A23K 10/30; C04B 28/14; C04B 18/0418; C04B 14/36; F03B 17/06; C02F 2103/08

(57) ABSTRACT

A combination desalination, hydroelectric power, and salt production system is described and the related methods. The comprehensive design solves problems and provides economic solutions to problems for arid regions. The system may comprise one of evaporating water from the concentrated brine water to precipitate salt, applying the concentrated brine water for agriculture, filling a recreational or therapeutic pools, mixing the concentrated brine water with gypsum to produce a masonry product, mixing the salt with cement to form a masonry product, mixing the salt with plastic, for example.

### FIELD OF THE INVENTION

The present invention relates to desalination systems, electrical power generating systems, and salt production and methods of use of the salt. The salt may be used for agriculture, recreational, healthcare, or industrial uses, for example.

### BACKGROUND OF THE INVENTION

The human population is growing rapidly and there is an urgent need for more energy production and access to more clean potable water for consumption. To provide sufficient water supply, many countries have installed desalination plants to remove the salt from ocean water or other brine (sodium chloride) containing waters. There are currently more than nineteen thousand desalination plants operating around the world.

Desalination plants produce potable water that is substantially salt free and, as a byproduct, concentrated salt water effluent (brine water). The brine water that is typically returned to the ocean near the desalination plant. Due to the removal of the potable water, brine water has a concentration of salt that is greater than the concentration of salt in the general ocean water. Therefore, the concentration of salt in the ocean water in the vicinity of the discharge of a desalination plant has a higher concentration of salt than the general ocean water. The higher concentration of salt is detrimental to coral reefs and other sea life.

There is a need for both clean power generation, greater clean water desalination without damaging the environment, and methods of using salt for production of construction materials.

### BRIEF DESCRIPTION OF THE DRAWINGS

FIG. 1 is a flow diagram of an embodiment of the system comprising desalinating salt water such as ocean water to produce a potable water stream and a brine water stream, producing electricity from using the high density brine water stream in a hydroelectric power generatinv facility, producing salt and/or a higher concentrated brine water stream by evaporation; and

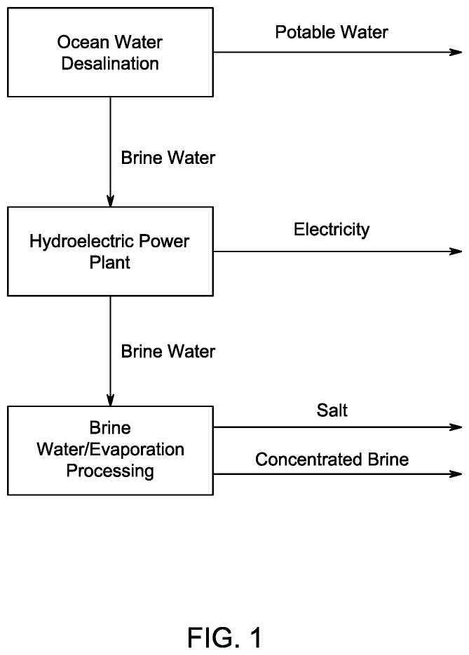

FIG. 2 is a diagrammatic elevation view in section of the embodiment of a method and structure of a porous wall for producing salt and brine water using the effluent of the hydroelectric power generating system mentioned in FIG. 1 according to the present invention; the structure comprises a reservoir 10, a porous structure 11 with the embodiment shown comprising an anthracite layer 11A, a sand layer 11B, a garnet layer 11C, and a gravel layer 11D adjacent to the reservoir, the brine water from the reservoir 10 may be sprayed 14 on the porous structure 11 by a mobile or rotating sprayer 13, and the further concentrated brine water is collected at the drain 15.

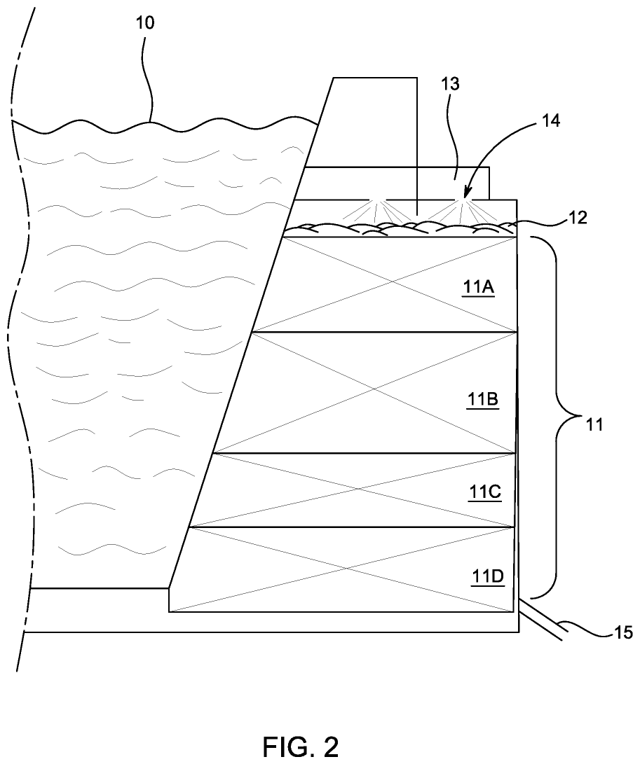

### DETAILED DESCRIPTION OF THE PREFERRED EMBODIMENTS

The world needs systems and methods to produce clean, potable water and clean renewable energy. These systems and methods, however, should not cause significant environmental damage themselves. The desalination of ocean salt water provides beneficial potable water for use in consumption and agriculture but also produces a detrimental high salt concentration brine effluent.

This high density brine effluent may be used in a hydroelectric facility to produce more electricity than if an equal amount of lower density water is used. The higher density brine water has greater potential energy than fresh water. Therefore, in one embodiment, the systems and methods comprise feeding the brine water from a desalination plant into a hydroelectric power plant. The brine water may then be further processed or returned to the ocean.

In another embodiment, the system and method comprise a desalination plant, a hydroelectric plant utilizing the brine water from the desalination plant as a water source, and a salt production facility. For example, the method may comprise processing salt water through a desalination plant to produce a potable water stream and a concentrated brine water stream, producing electricity by passing the concentrated brine water through a penstock to turn a turbine of a generator; and further processing the concentrated brine water at the effluent of the generator.

In some embodiments, the method may comprise further processing the concentrated brine water by one or more of the following process: 1) one of evaporating water from the concentrated brine water to precipitate salt from the concentrated brine water, 2) applying the concentrated brine water on a field of halophytes for growth, wherein the halophyte is salcornia, 3) filling a recreational or therapeutic pools with the concentrated brine water, mixing the concentrated brine water with gypsum to produce a masonry product, 4) mixing the concentrated brine water with gypsum to produce a masonry product, 5) mixing the salt with cement to form a masonry structure, masonry unit, or product, 6) mixing the salt with plastic for form a plastic building material, masonry unit, or other product, 7) other methods of producing salt or using the brine water. The masonry units may be concrete blocks, bricks, tiles, pavers, or other units.

The method may further comprise separating oils and other debris from the concentrated brine water prior to producing electricity and/or further processing the brine water. The oils may contaminate the concentrated brine water or salt for some applications.

In another embodiment, a concrete masonry unit comprising sodium chloride salt in a concentration range from 1 wt. % to 40 wt. % has been developed.

In another embodiment, a sheet rock, plaster, or wall board may be produced form the salt product or brine water, the sheet rock, plaster, or wall board may be produced form the salt product or brine water may comprise sodium chloride salt in a concentration range from 1 wt. % to 40 wt. %. The method of producing the sheet rock, plaster, or wall board may comprise mixing salt or brine water with gypsum. In a preferred embodiment, the salt or brine water is produced from the brine water effluent of a desalination plant. The brine water effluent from the desalination plant may be further processed through the hydroelectric facility prior to being used for concrete or gypsum production.

Embodiments of the method of power generation comprise utilizing the brine water from a desalination plant for use in a hydroelectric power generator including those described in U.S. Pat. Nos. 10,359,027 and 9,261,068, both patents are incorporated by reference in their entirety. Brine water with elevated concentrations of salt will also have a higher density and potential energy to produce more power through hydroelectric power generation than lower density salt free water.

The hydroelectric generation system can produce clean energy to power the desalination plant and other systems also. Wind and hydroelectric power generating systems have been known for a considerable period of time. Conventional hydroelectric systems utilize a natural geographic basin, valley, or the like, and place a man-made dam across a channel in the natural terrain to create a reservoir upstream of the dam. The water is then made to flow through one or more power generating turbines in the dam (or in a powerhouse constructed with the dam), to generate electrical power. Generally, only a single generating turbine is installed in each penstock of the facility, although multiple penstocks are common in a single conventional hydroelectric power generating system.

In some embodiments, wind power is generated with turbines connected to a generator. Wind blowing across or against the blades of the turbines causes the blades and thus an electric power generator to rotate thereby creating an electric current.

An example of such a conventional hydroelectric power generating system is found in Japanese Patent Publication No. 9,177,654, published on Jul. 11, 1997. This reference describes (according to the drawings and English abstract) a hydroelectric power generating system incorporating a single penstock run with multiple generating turbines installed. One embodiment is illustrated having an upstream reservoir and dam and a second downstream reservoir and dam, and generating turbines installed downstream of each dam.

Another example is found in Chinese Patent Publication No. 2,880,912 published on Mar. 21, 2007 to Wu Jinnan. A plurality of generating turbines is installed in series along stepped concrete bases downstream of the dam.

A method of producing electricity comprises flowing concentrated brine water from a desalination plant to a reservoir of a hydroelectric power generation system. The concentrated brine water may flow by canal, pipeline, or any other means, for example. The reservoir may comprise air bubble turbines, for example, air bubble turbines such as those described in U.S. Pat. No. 10,359,027. The method further comprises pumping the air from air compressors to the middle of the reservoir by pipes or tubes.

In such embodiments, the air bubble turbines comprise rotors with rotating blades, plates or paddles, (hereinafter “blades”) that may be impinged by the flow of the air bubbles through the water. The blades of the turbine may be flat, propeller blade, partial spheres, or spoon shape, for example. In some embodiments, there may be between one and twelve rotors per air bubble turbine. Further, in embodiments, there may be between three and eight blades connected to each rotor.

The method may further comprise directing the air under the blades with pipes or tubes. The air will flow from the compressor or compressors to produce the bubbles under the concentrated brine water to rotate the blades and the rotor. The rotor is connected to a generator that also rotates to produce electrical power. The rotor may further be connected to a gear box for example.

The air flow through the concentrated brine water produces at least two beneficial results. First, the energy of the air rising through the water column rotates the rotors and thus the axles of generators and the bubbles rising through the brie water causes water to evaporate thereby further concentrating the salt in the brine water from the desalination plant.

The evaporating water increases the local humidity that helps to makes a cloud farm.

The effluent (concentrated brine water) of the reservoir may be to for multiple purposes, for example:
1. Brine water may be used to generate electricity in a hydroelectric facility. In such embodiments, the desalination plant may be located at a greater elevation than the hydroelectric facility and the brine water effluent flows by gravity through the hydroelectric facility;
2. Brine water may be used to supply water to at least one saltwater swimming pool or pond, for example. The swimming pool may be large or small, public or private, or indoor or outdoor swimming pool. A high concentration brine swimming pool allows a swimmer to float on the water more easily and, if further supplemented, such as chloride, magnesium, bromide, sodium, calcium, or potassium, the swimmer may derive further health benefits which may provide natural remedies for cases of rheumatism, allergies, skin diseases, and aging of the skin. The method may comprise filling swimming pools or ornamental pools with the concentrated brine water.
3. Brine water may be used to water, feed and grow halophyte plants such as saliconia. Salicornia and other halophytes may be eaten raw, steamed, pickled for humans and as animal feed. Halophytes have a natural salty taste and other health benefits. The fibers may be processed into industrial products such as, but not limited to, paper and cardboard. Additional benefits of salicronia and other halophytes are described in S. Cardenas-Perez, A. Piernik, J. J. Chanona-Perez, M. N. Grigore, M. J. Perea-Flores, An Overview of the Emerging Trends of the Salicornia L. genus as a Sustainable Crop, Environmental and Experimental Botany, Volume 191, 2021, 104606, ISSN 0098-8472, http://doi.org/10.1016/j.envexpbot.2021.104606. (https://www.sciencedirect.com/science/article/pii/S0098847221002367), which is incorporated herein in its entirety.
4. The brine water may be further processed to produce solid salt. The inventor has surprisingly found that salt may be used to produce masonry products, dry wall, plaster, sheet rock, dry wall in combination with gypsum, cement, melted plastic, or combinations thereof, for example. Other property controlling or processing aids may be added, for example.

The reservoir of the hydroelectric facility may be any shape and constructed from any appropriate material. In some embodiments, the reservoir may comprise a rectangular, oval, or circular cross sectional shape. Further, in some embodiments, the reservoir may comprise reservoir walls. The reservoir walls may comprise a singular material or a combination of materials such as, but not limited to, concrete, earthen structures, sand, anthracite, stone, granite, garnet, other rocks, aggregate, or gravel, or combinations thereof, for example.

In one embodiment, the reservoir walls are built with a combination of at least two of anthracite, sand, garnet, and gravel surrounding the reservoir. As more concentrated brine water enters the reservoir, the brine water may overflow the reservoir through piping, weir, a canal, through the outer wall or walls of the reservoir, or other passageway.

In one embodiment, at least one canal is provided on a top portion of the reservoir walls or at the base of the reservoir walls at the exit of the penstock or both. In a specific embodiment, the canals drain, pumped, or sprayed over a porous wall such as a wall constructed from a porous material such as, but not limited to, small stones, rocks, anthracite, sand, garnet, gravel, or a combination thereof. The water seeps through the porous wall and may be collected at the bottom. For example, under the reservoir walls may be a water impermeable surface such as, but not limited to, cement, concrete, asphalt, plastic, or a combination thereof, for example. The water impermeable surface may be constructed with bottom drain channels or canals. As such, the water impermeable surface and the bottom drain canals define the bottom of the reservoir or the porous walls. In some cases, the canal may be more than 1 mile or 1 km around the reservoir.

In some embodiments, the reservoir may overflow into the canal and then drain directly through the reservoir wall. In other embodiments, a spray machine may collect and spray the concentrated brine water from the reservoir onto the reservoir wall to distribute the concentrated brine water and facilitate evaporation. The spray device may be a typical pressurized spray of may be similar to an irrigation watering device.

In some embodiments, the spray system may move around the reservoir distributing the brine water on top of the porous wall. The spray machine can be moving above the anthracite and other material to spray the brine water around the reservoir. When the concentrated brine water is sprayed or otherwise distributed around the reservoir, some of water evaporates further concentrating the concentrated brine water. As the brine water is distributed on the porous surface or other surface, further evaporation may occur naturally from low humidity, small droplets, or from solar radiation and ambient heat.

The method may comprise filtering the overflow of concentrated brine through the reservoir wall, the reservoir wall may comprise anthracite, sand, garnet, gravel, or combinations thereof for example. The water may be collected in the from the canal in the impermeable surface around the reservoir. This effluent may be stored, used in further industrial process, or for agriculture. Due evaporation and filtration of brine water, salts may be formed on the surface of the reservoir wall. This salt may be collected for further processing and used for the applications and methods described herein.

The salt may be collected to produce artificial salt caves either independently or in abandoned warehouses, malls, large space stores, or manufacturing facilities, for example. The artificial caves may be of a small size with each cave providing space for between 5 to 10 people. There may be men's and women's artificial salt caves with doors to enter and exit. The caves may comprise two fans; one for intake into the cave with some oxygen and the other fan exhausts the air out from the cave. Such salt caves may provide health benefits for people suffering from asthma, skin disease, sensitivity, aging skin, and other ailments.

Plastic articles and a method of making plastic articles is provided. The articles comprise or consist essentially of plastic and salt. The plastic may be virgin plastic or recycled plastic.

An embodiment of the method comprises melting plastic at a temperature above the melting point of the plastic and below its decomposition temperature or forming a plastic resin from monomers and blending salt with the liquid plastic. For example, certain typical recycled plastics melt at temperatures between 320° C. to 400° C. and do not burn or decompose significantly at such temperatures.

The method may further comprise adding a salt such as, but not limited to, sodium chloride to the melted plastic. The salt may be added in increments to ensure substantially consistent composition throughout the plastic. The salts may be added until the desired concentration is reached to form a plastic/salt slurry. The plastic salt slurry may be formed into articles by extrusion or molding, for example. One embodiment comprises molding the plastic/salt slurry into bricks, pavers, or other objects. The molding may be vacuum or compression molding, for example. The process may further comprise compressing the plastic/slat slurry in the mold to form a molded plastic/salt article. In an embodiment, the molded plastic/salt article may be crushed into different sizes to produce a plastic stone, such as small or medium sized plastic/salt stone, for example.

In some embodiments, the concentration of the plastic in the plastic/salt article should be greater than 2 wt. % and less than 60 wt. %. It has been found that the higher the percentage of plastic, the greater the strength of the plastic/salt article.

In one embodiment, the plastic/salt may be formed into stones or particles and may be used as large or small aggregate in concrete. The plastic/salt stone may be added to cement alone or in combination with other aggregates to form a concrete mix. The concrete may be used to make bricks, blocks, or other masonry unit. The bricks may be used in any way that conventional bricks, such as bricks for wall, building materials, floor concrete.

The plastic/salt resin may be molded into any object similar to other composite plastics. For example, a masonry unit made of plastic in the range of 50 wt. % to 70 wt. % and salt in the range of 30 wt. % to 40 wt. % can be used to form bricks, masonry units, tiles, or walls.

The method comprises preparing a plastic/salt slurry of plastic and salt. The plastic/salt slurry may then pumped or poured into molds to form the plastic/salt masonry units. The plastic/salt masonry units may be of any size including but not limited to, 4×4 or 4×8. The method may include compression molding the plastic/salt article and masonry units.

The plastic/salt article or masonry unit may be coated with a 100 wt. % plastic coating. The plastic coating may be desired to provide more cohesion and strength to the article or masonry unit.

The method may comprise adding additional aggregate to the plastic/salt slurry. The additional aggregate may be a limestone, sand, rocks, or other conventional aggregate.

For example, one embodiment comprises 40 wt. % to 60 wt. % plastic, 30 wt. % to 50 wt. % of an aggregate, and 5 wt. % to 20 wt. % salt. Embodiments of the method comprise preparing a slurry of 40 wt. % to 60 wt. % plastic, 30 wt. % to 50 wt. % aggregate, and 5 wt. % to 20 wt. % salt to form the plastic/sand/salt. The slurry may be heated to temperature within a range of 320 degrees C. to 400 degrees C. The method further comprises molding the plastic/sand/salt we take it out from the oven and put it in molds and press it hard until it be cools down and that way we can make a tiles for floor and tiles for walls such as backsplash tiles. Any of the embodiments listed above may further comprise cement.

The hydroelectric power generating system comprises a dam structure that defines a brine water reservoir enclosed therein. The brine water may be effluent from a desalination plant. In a typical desalination plant, saltwater, for example ocean water or other inland saltwater source, are processed wherein approximately one third (33%) of water is desalinated and approximately two thirds of the water is concentrated brine water. In such a process, the concentrated brine water comprises approximately 50% more salt than the original salt water. This water is conventionally returned to the ocean and may cause environmental problems due to the increased salt concentration.

In embodiments of the invention, the effluent concentrated brine water is fed to the porous wall or other evaporation structure. The porous wall or other evaporation structure and transport of the concentrated water enables the hydroelectric power generating for power generation. The hydroelectric power may be generated as described in U.S. Pat. No. 10,359,027, which is incorporated herein in its entirety. The concentrated brine water has a higher density that fresh water and therefore more potential energy to drive the hydroelectric plant.

In one embodiment, a canal or porous material or other evaporation structure (as described herein) may at least partially surround the reservoir. The brine water in the reservoir may flow directly into the penstocks or into a canal.

In one embodiment of the porous wall, it is envisioned that the top portion of the porous wall could comprise layers of anthracite, sand, garnet, and on the bottom gravel. In one embodiment, the layers of the porous wall are layered in the order as described. Under the porous wall is a water impermeable water collection layer. In some embodiments, the water impermeable layer may be, but is not limited to, concrete, cement, plastic, or a combination thereof to provide an effluent discharge. The channel for the effluent discharge at the bottom of the reservoir and will be more than 1 mile or 1 km around the reservoir, for example.

The brine water may overflow, be sprayed, or pumped onto the porous wall or other evaporation structure to facilitate evaporation and salt precipitation. The brine water may be applied to the porous wall or other structure by any spray apparatus including a mobile spray machine typically used for irrigation to spray the brine water. In other embodiments, the brine water may be sprayed through stationary sprayers. The stationary sprayers may be similar to snow making machines, for example. The brine water may alternatingly be sprayed different areas of the porous material or rotate around the perimeter of the reservoir to provide time for the water to evaporate and filter through the porous wall or other evaporation structure, for example.

Spraying the brine water around the reservoir results in further water evaporation which will help to form clouds in arid regions. Spraying in addition to the evaporation caused by air flow through in the middle of the reservoir, in some embodiments, helps to reduce the temperature, especially in hot countries.

In another embodiment, the brine water is filtered by porous wall such as through the anthracite, sand, garnet, gravel, or combination thereof. The filtered brine water may be collected in the bottom by canal around the reservoir and the filtered concentrated brine may be stored for agricultural or industrial uses as described herein.

In other embodiments, the concentrated brine water may be further processed to produce a solid salt product. For example, after evaporation and filtration of brine water, salts are formed on the surface of the top porous wall. Embodiments of the method include collecting the salts from the top of the porous wall.

In one embodiment, the ocean water or other salt water may be pumped to an arid location that requires additional sources of water provided by a desalination plant. The water may be desalinated at such a location and the effluent concentrated brine water may be utilized to produce electricity and salt.

The hydroelectric power generation facility described in U.S. Pat. No. 10,359,027 comprises at least one sluice gate, or in other embodiments, a plurality of such gates, that feed water a peripheral canal near the top of the dam. The peripheral canal, in turn, feeds at least one penstock, and preferably a plurality of such penstocks. Each penstock includes at least one electrical generating turbine, and preferably a plurality of such turbines. The downstream end of the penstock or penstocks feed into an enclosed circumferential channel within the base of the dam, directly onto the porous wall, or other evaporation structure.

In some embodiments, the peripheral canal may not feed into penstocks comprising electrical generating turbines but may be fed or sprayed onto an evaporation structure to allow a portion of the water to be evaporated and salt to precipitate from the concentrated brine water. In some embodiments, a portion of the brine water is fed through the penstocks and a portion of the brine water is sprayed or otherwise applied directly to the evaporation structure. The further concentrated water and/or salt may be used, as described above.

The system uses water to generate essentially clean (reduced greenhouse gas producing) energy. Construction of a sufficient number of such facilities, and/or of sufficient water volume, would result in some slight reduction in sea level as water is drawn from the oceans to the reservoirs. The reservoirs would also serve as convenient water recreational sites, as any number of such facilities could be constructed convenient to large population centers, as opposed to conventional hydroelectric dams and their reservoirs. The hydroelectric power generating system would make use of salt water from the sea or the desalination plant, rather than fresh water. The dissolved salt and minerals in the water may prove to be of some benefit to some individuals. Also, it is anticipated that the relatively large volume of ocean water captured within the dams would provide a practical environment for the farming of many ocean-dwelling fish and other marine life, as well as serving to protect endangered species of marine life.

These and other features of the present invention will become readily apparent upon further review of the following specification and drawings. Similar reference characters denote corresponding features consistently throughout the attached drawings.

In one potential embodiment, the hydroelectric power generating system and salt producing system includes a reservoir, a common canal or water way may surround the reservoir, and a water evaporation structure may surround the reservoir to produce salt. The vessel can be positioned proximate a water desalination plant.

The hydroelectric power generating system may include a plurality of primary wind turbines on the reservoir and a plurality of aft columns vertically disposed within the reservoir, Each of the plurality of air columns includes a plurality of bubble turbines (desirably six to nine bubble turbines per air column, for example). An air compressor AC is in communication with the wind turbines. The wind turbines may power the aft compressor AC. The aft compressor produces compressed air or bubbles to the reservoir, which are used by the bubble turbines. The primary wind turbines and the bubble turbines can further be in communicating relation with a junction box, so that the energy generated by each of the primary wind turbines and each of the bubble turbines can be transferred to the junction box and, subsequently, transferred to a power grid (not shown), such as through power lines PL, and/or used as a power source for the aft compressor AC.

The reservoir may have any suitable shape, such as a substantially circular shape, a substantially oval shape, or a substantially rectangular shape, and can be formed from any suitable material, such as concrete. It is to be noted that the size of the reservoir can vary depending on the amount of energy that is required to be produced. It is to be understood that the present invention is not limited to the embodiments described above but encompasses any and all embodiments within the scope of the following claims.

1. A method of desalinating salt water and hydroelectric system, comprising:
processing salt water through a desalination plant to produce a potable water stream and a concentrated brine water stream;
producing electricity by passing the concentrated brine water through a penstock to turn a turbine of a generator; and
further processing the concentrated brine water.

2. The method of claim 1, wherein further processing the concentrated brine water comprises one of evaporating water from the concentrated brine water to precipitate salt.

3. The method of claim 1, wherein further processing the concentrated brine water comprises applying the concentrated brine water on a field of halophytes.

4. The method of claim 3, wherein the halophyte is salcornia.

5. The method of claim 1, wherein further processing the concentrated brine water comprises filling a recreational or therapeutic pool with the concentrated brine water.

6. The method of claim 1, wherein further processing the concentrated brine water comprises mixing the concentrated brine water with gypsum to produce a masonry product.

7. The method of claim 1, wherein further processing the concentrated brine water comprises mixing the concentrated brine water with gypsum to produce a masonry product.

8. The method of claim 1, comprising separating oils from the concentrated brine water prior to producing electricity.

9. The method of claim 2, comprising mixing the salt with cement to form concrete.

10. The method of claim 9, comprising forming the concrete into masonry units.

11. The method of claim 10, wherein the masonry units are concrete blocks, tiles, or pavers.

12. A concrete masonry unit, comprising:
sodium chloride salt in a concentration in a concentration range from 1 wt. % to 40 wt. %.
